(19) United States
(12) Patent Application Publication
(10) Pub. No.: US 2020/0249650 A1
(43) Pub. Date: Aug. 6, 2020

(54) NUMERICAL CONTROL SYSTEM

(71) Applicant: Fanuc Corporation, Yamanashi (JP)

(72) Inventors: Kazuhiro Satou, Minamitsuru-gun (JP); Kazunori Iijima, Minamitsuru-gun (JP)

(73) Assignee: Fanuc Corporation, Yamanashi (JP)

(21) Appl. No.: 16/750,796

(22) Filed: Jan. 23, 2020

(30) Foreign Application Priority Data
Jan. 31, 2019 (JP) 2019-015170

(51) Int. Cl. G05B 19/408; G05B 19/406; G06N 5/04

(52) U.S. Cl. CPC G05B 19/408; G06N 5/04; G05B 19/406

(57) ABSTRACT

A numerical control system includes: a context acquisition unit that acquires a context in a machining operation of a machine tool; a state amount detection unit that determines a control state amount of each axis of the machine tool; a state data extraction unit that extracts state data from the state amount by using an extraction pattern based on the context; a feature amount creation unit that creates a feature amount featuring the operation state of the machine tool from the state data; an inference calculation unit that calculates an evaluation value of the operation state based on the feature amount; and an anomaly determination unit that determines the operation state based on a calculation. The numerical control system can detect an anomaly of the operation state in a wider range even when a motor operation pattern during machining, a tool, a work is different.

### RELATED APPLICATION

The present application claims priority to Japanese Application Number 2019-015170 filed Jan. 31, 2019, the disclosure of which is hereby incorporated by reference herein in its entirety.

### BACKGROUND OF THE INVENTION

### 1. Field of the Invention

The present invention relates to a numerical control system, in particular, relates to a numerical control system that determines the operation state of a machine tool by switching learning models.

### 2. Description of the Related Art

In machine tools that machine a work by moving a tool and the work relatively (for example, a machining center, a lathe turning machine, or the like), there is a technique to determine that the operation state of a machine tool is abnormal when a large load is applied to a motor that rotates a spindle (a spindle motor) or a motor that moves a tool (a feed axis motor) during machining of a work, when an abnormal temperature is detected, when an impact or an abnormal sound is detected, or the like (for example, Japanese Patent Laid-Open No. 2009-080752, Japanese Patent Laid-Open No. 2008-110435, Japanese Patent Laid-Open No. 2007-072879, Japanese Patent Laid-Open No. H09-076144, and the like).

When an anomaly of the operation state of a machine tool is determined based on information that can be externally observed during machining, however, state information on machining that is externally observed in the abnormal operation state of the machine tool differs in accordance with machining details (rough machining, finishing machining, or the like). In more detail, state information on machining that is externally observed differs in accordance with the motor operation pattern including a rotational rate, a feed rate, or the like of a spindle being used in machining, a type of a tool being used in machining, a material of a work to be machined, or the like. It is thus difficult to create a general-purpose machine learning device (a general-purpose learning model) that can be utilized for detecting an anomaly of the operation state of a machine tool in association with these various situations, because a large amount of state information detected in various situations is required.

### SUMMARY OF THE INVENTION

Accordingly, there is a demand for a numerical control system that can more widely detect an anomaly of the operation state of a machine tool even when a motor operation pattern, a tool, a work, or the like during machining is different.

In a numerical control system according to one aspect of the present invention, the above problem is solved by changing an extraction method of state data used in a process related to machine learning (learning or inference) in accordance with a context indicating operation status including a motor operation pattern during machining or the status such as a type of a tool used in machining, a type of a work to be machined, or the like. More specifically, the numerical control system according to one aspect of the present invention extracts state data from a state amount determined during machining by using an extraction pattern based on a context and selects an extraction pattern used for extraction of state data from a plurality of extraction patterns in accordance with the context.

Further, one aspect of the present invention is a numerical control system that determines the operation state of a machine tool, and the numerical control system includes: a context acquisition unit that acquires a context in a machining operation of a machine tool; a state amount detection unit that determines a control state amount of each axis of the machine tool; a state data extraction unit that extracts state data from the state amount by using an extraction pattern based on the context in the machining operation acquired by the context acquisition unit; a feature amount creation unit that creates a feature amount featuring the operation state of the machine tool from the state data; an inference calculation unit that calculates an evaluation value of the operation state of the machine tool based on the feature amount; and an anomaly determination unit that determines the operation state of the machine tool based on a calculation result from the inference calculation unit.

With the one aspect of the present invention, since it is possible to extract state data suitable for a situation by selecting an extraction pattern in accordance with a context of the operation status of a machine tool, an environmental status, or the like during machining, it is possible to efficiently perform a process (learning or inference) related to machine learning.

### BRIEF DESCRIPTION OF THE DRAWINGS

Previously described and other objects and features of the present invention will be apparent from description of the following embodiments with reference to the attached drawings, in which:

FIG. 1 is a schematic hardware configuration diagram illustrating a primary portion of a numerical control system according to one embodiment;

FIG. 2 is a schematic function block diagram of the numerical control system according to a first embodiment;

FIG. 3A is a diagram illustrating an extraction process of state data when not using an extraction pattern according to one aspect of the present invention;

FIG. 3B is a diagram illustrating an extraction process of state data when not using an extraction pattern according to one aspect of the present invention;

FIG. 3C is a diagram illustrating an extraction process of state data when not using an extraction pattern according to one aspect of the present invention;

FIG. 4A is a diagram illustrating an extraction process of state data when using an extraction pattern according to one aspect of the present invention;

FIG. 4B is a diagram illustrating an extraction process of state data when using an extraction pattern according to one aspect of the present invention;

FIG. 4C is a diagram illustrating an extraction process of state data when using an extraction pattern according to one aspect of the present invention;

FIG. 5 is a schematic function block diagram of a numerical control system according to a second embodiment;

FIG. 6 is a schematic function block diagram of a numerical control system according to a third embodiment;

FIG. 7 is a schematic function block diagram illustrating a modified example of a numerical control system according to a fourth embodiment; and

FIG. 8 is a schematic function block diagram of a numerical control system according to a fifth embodiment.

### DETAILED DESCRIPTION OF THE PREFERRED EMBODIMENTS

Embodiments of the present invention will be described below along with the drawings.

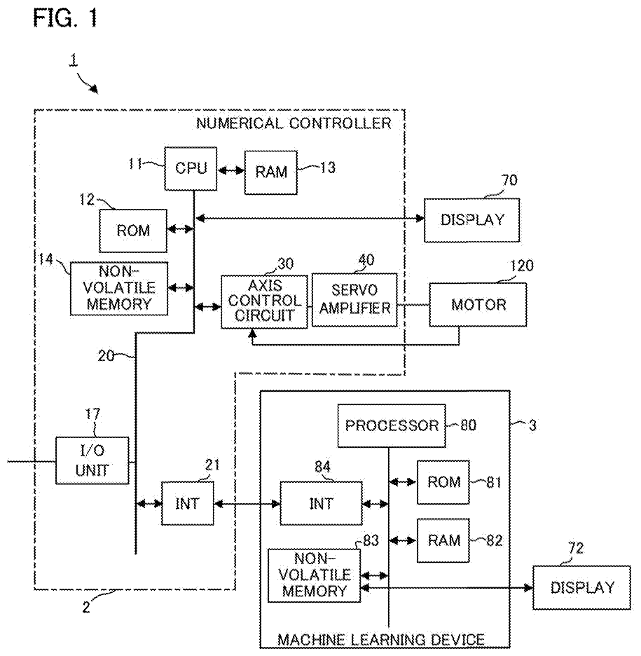

FIG. 1 is a schematic hardware configuration diagram illustrating a primary portion of a numerical controller and a machine learning device forming a numerical control system 1 according to one embodiment of the present invention. A CPU 11 provided in a numerical controller 2 according to the present embodiment is a processor that entirely controls the numerical controller 2. The CPU 11 reads a system program stored in a ROM 12 and controls the entire numerical controller 2 in accordance with the system program. A RAM 13 temporarily stores temporary calculation data or display data, various data input by an operator via an input unit (not illustrated), or the like. The numerical controller 2 may include a non-volatile memory 14. The non-volatile memory 14 is backed up by a battery (not shown), and retains its stored state even when the power of the numerical controller is turned off. The numerical controller 2 includes an I/O unit 17 and outputs a signal to an external device (not shown).

A display 70 is formed of a liquid crystal display device or the like. On the display 70, an immediate value or a history of inferred evaluation values indicating the abrasion status of a tool may be displayed. In an implementation of a proposed system, the final result can be obtained with various method such as a threshold determination scheme, a trend graph determination scheme, an outlying observation scheme, or the like. With visualization of a part of the course before the final result is obtained, an operator actually who is operating a machine tool in a production site is able to obtain a result consistent with industry intuition.

An axis control circuit 30 used for controlling an axis provided in a machine tool outputs an instruction for an axis to a servo amplifier 40 in response to receiving a motion instruction amount of the axis from the CPU 11. In response to such an instruction, the servo amplifier 40 drives a motor 120 that moves the axis provided in a machining machine. The motor 120 of the axis has a built-in position/speed detector, feeds a position/speed feedback signal from the position/speed detector back to the axis control circuit 30, and performs feedback control of the position and speed. Note that, although only the single axis control circuit 30, the single servo amplifier 40, and the single motor 120 are illustrated in the hardware configuration diagram of FIG. 1, these components are prepared in accordance with the number of axes provided in a machining machine to be controlled in the actual implementation.

An interface 21 is an interface used for connecting the numerical controller 2 to a machine learning device 3. The machine learning device 3 includes a processor 80 that integrally controls the entire machine learning device 3, a ROM 81 that stores a system program, a learning model, or the like, and a RAM 82 that performs temporary storage in each process related to machine learning. The machine learning device 3 transfers various data with the numerical controller 2 via an interface 84 and the interface 21. Further, a result of a process performed by the machine learning device 3 may be displayed on a display 72 for confirmation. The machine learning device 3 may include a non-volatile memory 83. The non-volatile memory 83 is backed up by a battery (not shown), and retains its stored state even when the power of the machine learning device 3 is turned off.

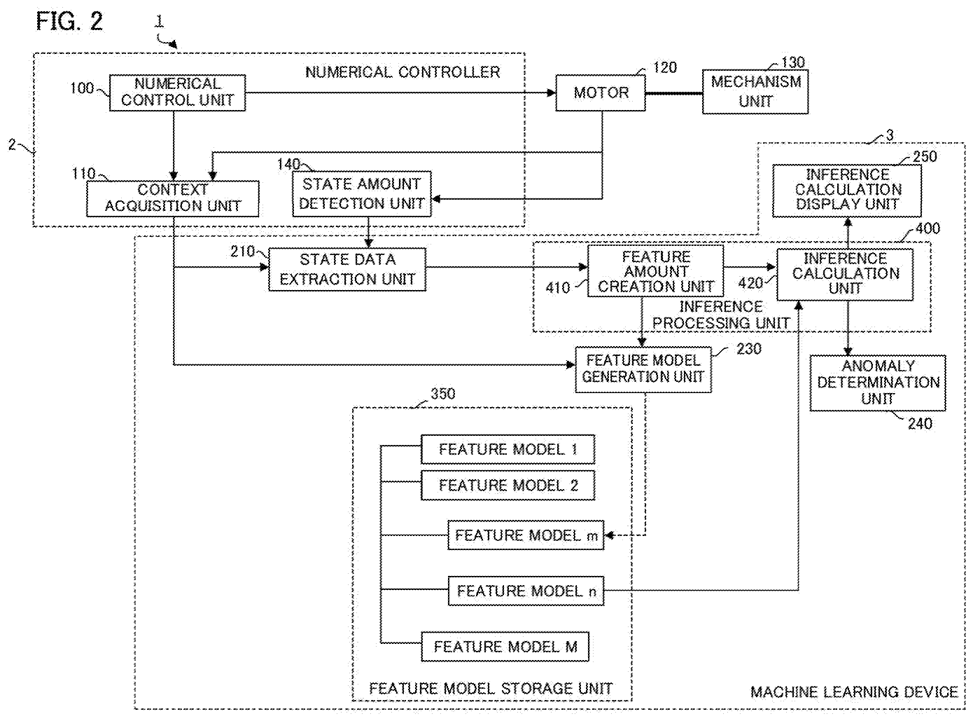

FIG. 2 is a schematic function block diagram of the numerical control system 1 according to the first embodiment. Each functional block illustrated in FIG. 2 is realized when the CPU 11 provided in the numerical controller 2 forming the numerical control system 1 illustrated in FIG. 1 or the processor 80 such as a GPU provided in the machine learning device 3 configured on a computer such as a fog computer, a cloud server, or the like controls the operation of respective components of the devices in accordance with respective system programs.

The numerical control system 1 of the present embodiment includes a numerical control unit 100, a context acquisition unit 110, and a state amount detection unit 140 on the numerical controller 2 as an edge device targeted for observation and inference of at least the state thereof. Further, the numerical control system 1 includes an inference machining unit 400 that performs inference on the state of an edge device and a feature model storage unit 350 that stores and manages a plurality of feature models. The numerical control system 1 of the present embodiment further includes a state data extraction unit 210 that extracts state data used for a process such as inference from a state amount determined by the state amount detection unit 140, an anomaly determination unit 240 that detects an anomaly of the operation state of a machine tool based on a result inferred by the inference machining unit 400 for the state of an edge device, an inference calculation display unit 250 by which the inference machining unit 400 displays inference calculation on a display or the like with respect to the state of the edge device, and a feature model generation unit 230 that creates and updates a feature model stored in the feature model storage unit 350.

The numerical control unit 100 of the present embodiment executes a block of a machining program stored in a memory device (not illustrated) and thereby controls a machine tool that machines a work. The numerical control unit 100 sequentially reads and analyzes a block of a machining program stored in a memory device (not illustrated), calculates a motion amount of the motor 120 per control cycle based on the analyzed result, and controls the motor 120 in accordance with the calculated motion amount per control cycle. The machine tool controlled by the numerical control unit 100 includes a mechanism unit 130 driven by the motor 120. When the mechanism unit 130 is driven, a tool and a work are moved relatively, and the work is machined. Note that, although omitted in FIG. 2, the motor 120 is prepared for the number of axes provided in the mechanism unit 130 of the machine tool. The mechanism unit 130 includes a ball screw used as a feed axis or a mechanism used as a spindle, for example. A single mechanism unit may be driven by a plurality of motors.

The context acquisition unit 110 acquires a context (machining status, operation status, environmental status, or the like) in a machining operation performed by the numerical control unit 100 (and a machine tool controlled by the numerical control unit 100) and outputs the acquired context to the machine learning device 3. The context in a machining operation may be, for example, a motor operation pattern during machining (a spindle rotational rate, a feed rate, or the like), a purpose of currently performed machining (rough machining, finishing machining, or the like), a purpose of currently performed driving of a movable part (rapid traverse, cutting traverse, or the like), a type of a tool used for machining, work information indicating a hardness, a material, or the like of a work to be processed, or the like.

The context acquisition unit 110 acquires a context in a machining operation, in which the context is determined comprehensively based on a machining condition instructed by a machining program, setting information set to the numerical control unit 100 by an operator via an input device (not illustrated), setting information set to the numerical control unit 100 by another computer connected via a network or the like, information detected by a device such as a sensor individually provided in the numerical control unit 100, a value of a signal acquired from a programmable logic controller (PLC), or the like. The context acquisition unit 110 then outputs the context in the machining operation to the feature model storage unit 350, the state data extraction unit 210, and the feature model generation unit 230. The context acquisition unit 110 has a roll of notifying each unit in the numerical control system 1 of the context in the current machining operation related to the numerical control unit 100, which is an edge device, as a context in a machining operation used for selecting an extraction pattern.

The state amount detection unit 140 determines the state of a machining operation performed by the numerical control unit 100 (and a machine tool controlled by the numerical control unit 100) as a state amount of the machining operation. The state amount of [symbol] a machining operation may be, for example, a load of a spindle (current), a load of a feed axis (current), a spindle rotational rate, a feed axis rate, a feed axis position, a temperature of the motor 120, a vibration value, a sound, or the like. The state amount detection unit 140 determines, as a state amount of a machining operation, a current flowing in the numerical control unit 100 or the motor 120 that drives the mechanism unit 130 of a machine tool controlled by the numerical control unit 100 or a detection value determined by a device such as a sensor individually provided in each unit, for example. The state amount of a machining operation determined by the state amount detection unit 140 is output to the state data extraction unit 210.

The state data extraction unit 210 extracts state data used for an inference process or the like performed by the inference machining unit 400 from the state amount of a machining operation determined by the state amount detection unit 140. The state data extraction unit 210 extracts state data used for an inference process or the like from the state amount of a machining operation determined by the state amount detection unit 140 in accordance with a predetermined extraction pattern based on the context in a machining operation input from the context acquisition unit 110.

The extraction pattern used by the state data extraction unit 210 is a predetermined data machining method in which the parameter is determined based on a context in a machining operation. The extraction pattern may be, for example, setting of an extraction section of time-series data derived based on a context in a machining operation, selection of data, edition of data such as a scale change of a state amount based on a context in a machining operation, or the like. In the present embodiment, the extraction pattern used by the state data extraction unit 210 may be registered in a memory device in advance by an operator.

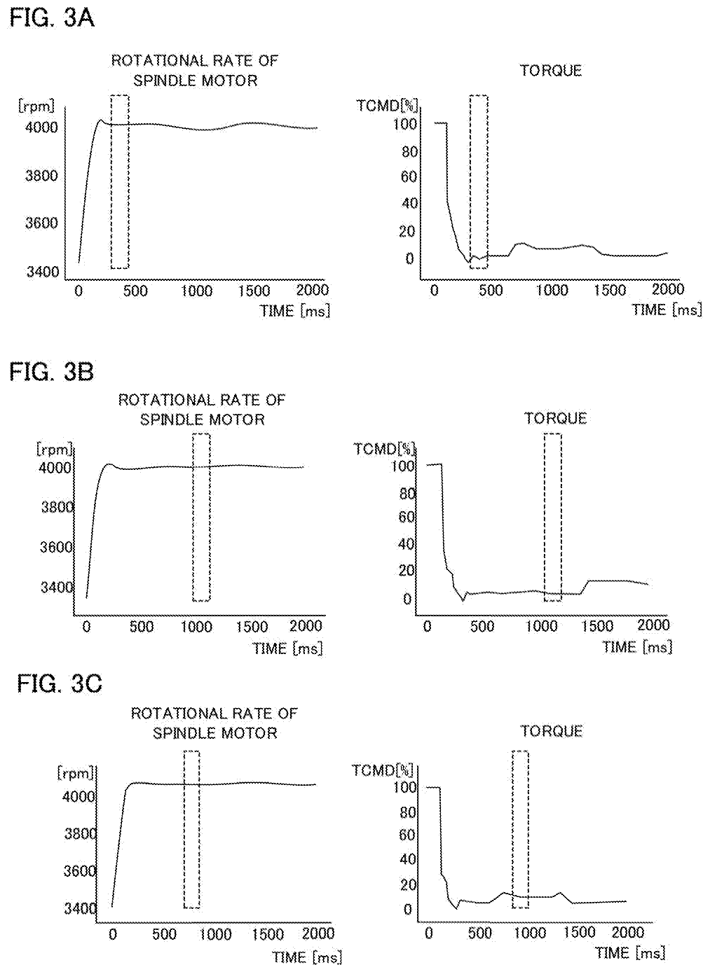

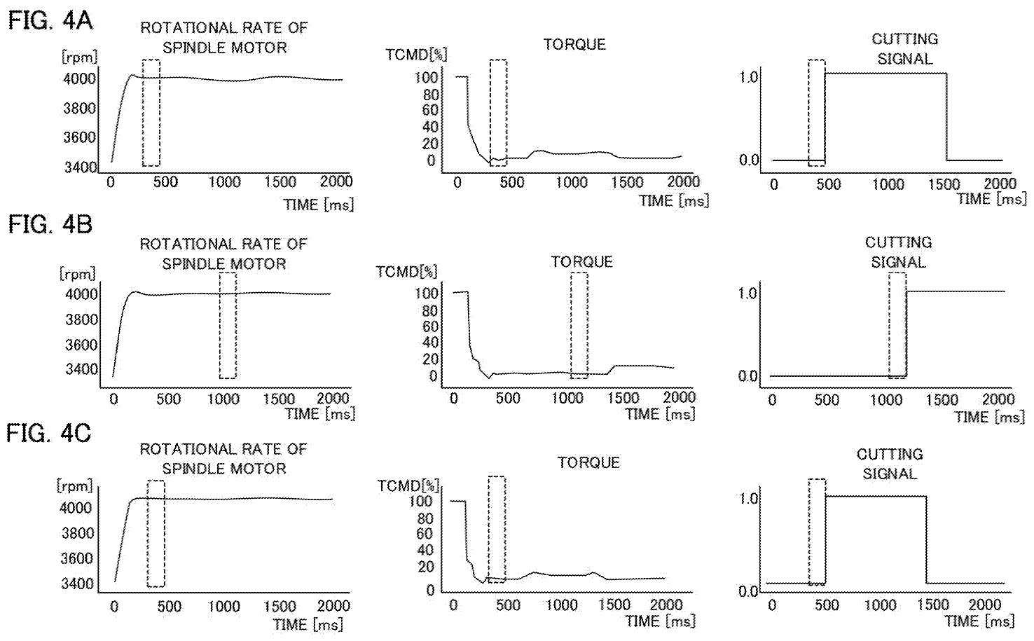

An extraction method of state data from a state amount in accordance with a predetermined extraction pattern based on a context in a machining operation will be described below with reference to FIG. 3A to FIG. 3C and FIG. 4A to FIG. 4C. FIG. 3A to FIG. 3C illustrate examples in which time-series data of the rotational rate and the torque of a spindle motor attached to a tool is determined as a state amount from a machine tool during machining. Each set of time-series data of a rotational rate and a torque of a spindle motor of FIG. 3A, FIG. 3B, and FIG. 3C is acquired at a predetermined time when the spindle motor is driven. The following case will be considered in this extraction method. From the above state amount, a predetermined length of time-series data obtained when the spindle motor is rotating at a constant rotational rate of around 4000 rpm and running idle is extracted as state data input to a machine learning device. In such a case, time-series data of a predetermined section in which the spindle motor is rotating at around 4000 rpm and the torque value exhibits a lower value than a predetermined threshold can be acquired as state data, for example. For example, when time-series data of a section surrounded by a dotted line in FIG. 3A or FIG. 3B is extracted, targeted state data can be acquired.

In such a process, however, it may be difficult to acquire targeted state data when a change of the value in the acquired state amount does not clearly appear. For example, as seen in the example illustrated in FIG. 3, when the change in torque between the torque at the time of idle running and the torque at the time of machining is small and when the threshold related to the torque is not suitably set in advance, time-series data of a section when the spindle motor is rotating at a constant rotational rate at around 4000 rpm but the tool attached to the spindle is not running idle (which is performing machining) as illustrated in FIG. 3C may be erroneously extracted as targeted state data.

FIG. 4A to FIG. 4C are examples in which time-series data of the rotational rate and the torque of a spindle motor attached to a tool are determined from a machine tool during machining and a cutting signal is acquired as a context in a machining operation. In the examples of FIG. 4A to FIG. 4C, the cutting signal, which is a signal indicating whether or not machining is being performed, is acquired as a context in a machining operation, and a section where state data is extracted from a state amount of a machining operation can be determined by utilizing the context. For example, when an extraction pattern: “extract, as state data, a predetermined section immediately before a cutting signal of a context of a machining operation is switched from idle running (0.0) to cutting (1.0)” is set in advance, targeted state data can be extracted without any problem in all the examples of FIG. 4A to FIG. 4C.

The inference machining unit 400 of the present embodiment observes the state of the numerical control unit 100 (and a machine tool controlled by the numerical control unit 100), which is an edge device, and infers a state of the numerical control unit 100 (a state of machining) based on the observed result.

A feature amount creation unit 410 provided in the inference machining unit 400 creates a feature amount indicating a feature of the operation state of a machine tool of the numerical control unit 100 based on the state data extracted by the state data extraction unit 210. The feature amount indicating a feature of an operation state of a machine tool created by the feature amount creation unit 410 is information that is useful as a basis of determination in detecting an anomaly of the operation state of a machine tool in a machining operation performed by the numerical control unit 100 (and a machine tool controlled by the numerical control unit 100). Further, a feature amount indicating a feature of the operation state of a machine tool created by the feature amount creation unit 410 is input data when an inference calculation unit 420 performs inference using a learning model described later.

The feature amount indicating a feature of the operation state of a machine tool created by the feature amount creation unit 410 may be, for example, a value obtained by sampling the load of the spindle, which is state data extracted by the state data extraction unit 210, at a predetermined sampling cycle for a past predetermined period, may be, for example, a peak value of the vibration value of the motor 120, which is state data determined and extracted by the state data extraction unit 210, within a past predetermined period, or may be, for example, a value obtained by a combination of signal machining such as integration conversion of respective state data extracted by the state data extraction unit 210 into a time-series frequency domain, standardization of the amplitude or the power density, adaptation to a transfer function, reduction of dimensions to a particular time or frequency width, or the like. The feature amount creation unit 410 performs pre-processing of the state data extracted by the state data extraction unit 210 so as to be handled by the inference calculation unit 420 and normalizes the pre-processed state data.

The inference calculation unit 420 provided in the inference processing unit 400 infers an evaluation value of the operation state of a machine tool performed by the numerical control unit 100 (and a machine tool controlled by the numerical control unit 100) based on a feature model selected from the feature model storage unit 350 based on a context in a machining operation of a machine tool input from the context acquisition unit 110 and on a feature amount created by the feature amount creation unit 410.

The inference calculation unit 420 is realized by applying a feature model stored in the feature model storage unit 350 to a platform on which an inference process by machine learning can be performed. For example, the inference calculation unit 420 may be a component used for performing an inference process using a multilayer neural network or may be a component used for performing an inference process using a known learning algorithm as machine learning, such as a Bayesian network, a support vector machine, a mixed Gaussian model, or the like. Further, the inference calculation unit 420 may be a component used for performing an inference process using a learning algorithm such as supervised learning, unsupervised learning, reinforcement learning, or the like, for example. Further, the inference calculation unit 420 may be capable of performing an inference process based on multiple types of learning algorithms, respectively.

The inference calculation unit 420 infers an evaluation value of the operation state of a machine tool performed by the numerical control unit 100 (and a machine tool controlled by the numerical control unit 100) by configuring a machine learning device based on a feature model selected from the feature model storage unit 350 and performing an inference process using a feature amount created by the feature amount creation unit 410 as input data of the machine learning device. The evaluation value, which is a result inferred by the inference calculation unit 420, may be, for example, a classification as to whether the operation state of the machine tool is normal or abnormal, information indicating an abnormal part of the machine tool in an operation state (an anomaly of a bearing of the motor 120, a failure of a connection part between the motor 120 and the mechanism unit 130, or the like), or information indicating a state such as a distance between the current operation state of a machine tool and a distribution of a normal operation state of the machine tool.

The feature model storage unit 350 of the present embodiment can store a plurality of feature models associated with a combination of contexts in a machining operation input from the context acquisition unit 110. The feature model storage unit 350 can be implemented as a numerical controller, a cell computer, a fog computer, a cloud server, a database server, or the like, for example.

The feature model storage unit 350 stores a plurality of models 1, 2, . . . , M associated with a combination of contexts (machining status, operation status, environmental status, or the like) in a machining operation specified by the context acquisition unit 110. The combination of contexts (machining status, operation status, environmental status, or the like) in a machining operation as used herein means a combination related to values, a range of values, or a list of values that may be taken by respective contexts in machining operations. For example, when the combination of contexts is a combination of a spindle rotational rate, a feed rate, a cutting signal, a tool type, and work information, “spindle rotational rate: 500 to 1000 [min⁻¹], feed rate: 200 to 300 [mm/min], during cutting, drill tool, aluminum/steel” can be used as one of the combinations of contexts in the machining operation.

With respect to the feature model stored in the feature model storage unit 350, one feature model adapted to the inference process in the inference calculation unit 420 is stored as configurable information. When configured as a feature model using a learning algorithm of a multilayer neural network, for example, the feature model stored in the feature model storage unit 350 may be stored as the number of neurons (perceptrons) in each layer, a weight parameter between neurons (perceptrons) in each layer, or the like. Further, in a case of a feature model using a learning algorithm of a Bayesian network, the feature model may be stored as a transition probability between nodes forming the Bayesian network or the like.

Respective feature models stored in the feature model storage unit 350 may be feature models using the same learning algorithm or may be feature models using different learning algorithms, which may be a feature model using any learning algorithms as long as it can be utilized for the inference process performed by the inference calculation unit 420.

The feature model storage unit 350 may store a single feature model in association with a combination of contexts in a single machining operation or may store feature models using two or more different learning algorithms in association with a combination of contexts in a single machining operation. The feature model storage unit 350 may store feature models using different algorithms in association with respective combinations of contexts in a plurality of machining operations in which the ranges of the combinations are overlapped. At this time, by further defining a use requirement such as a required machining capacity, a type of a learning algorithm, or the like with respect to a feature model corresponding to a combination of contexts in a machining operation, the feature model storage unit 350 can select a feature model in accordance with the inference calculation units 420 having different executable inference processes or processing capacities with respect to a combination of contexts in a machining operation, for example.

In response to externally receiving a read/write request of a feature model including a combination of contexts in a machining operation, the feature model storage unit 350 performs reading/writing on a feature model stored in association with the combination of contexts in the machining operation.

At this time, information on an executable inference process or a processing capacity of the inference calculation unit 420 may be included in a read/write request of a feature model, and in such a case, the feature model storage unit 350 performs reading/writing on a feature model associated with both a combination of contexts in a machining operation and an executable inference process or a machining capacity of the inference calculation unit 420. The feature model storage unit 350 may have a function by which reading/writing is performed on a feature model associated with (a combination of) contexts in the machining operation based on the contexts in the machining operation input from the context acquisition unit 110 in response to an external read/write request of a feature model. With such a function being provided, it is no longer necessary to additionally provide a function of requesting a feature model based on a context in a machining operation input from the context acquisition unit 110 to the inference calculation unit 420 or the feature model generation unit 230.

Note that the feature model storage unit 350 may encrypt and store a feature model generated by the feature model generation unit 230 and decrypt the encrypted feature model when the feature model is read by the inference calculation unit 420.

The anomaly determination unit 240 determines the operation state (an anomaly of a machine or the like) of the numerical control unit 100 (and a machine tool controlled by the numerical control unit 100) based on an evaluation value of the operation state of a machine tool inferred by the inference machining unit 400. For example, the anomaly determination unit 240 determines whether the operation state of a machine tool is normal or abnormal in accordance with the content of the evaluation value, which is an inference result, output by the inference calculation unit 420. For example, the anomaly determination unit 240 may determine that the operation state of a machine tool is abnormal if the current operation state of the machine tool inferred by the inference processing unit 400 is classified into the abnormal state and, otherwise, determine that the operation state of the machine tool is normal. For example, the anomaly determination unit 240 may determine that the operation state of the machine tool is abnormal if the distance between the current operation state of a machine tool and a distribution of a normal operation state of the machine tool exceeds a predetermined threshold defined in advance and, otherwise, determine that the operation state of the machine tool is normal.

The anomaly determination unit 240 may notify an operator of an anomaly of the operation state of a machine tool by using a display device, a lamp, an audio output device, or the like (not illustrated) when determining that the operation state of the machine tool is abnormal. Further, the anomaly determination unit 240 may instruct the numerical control unit 100 to suspend the machining when determining that the operation state of the machine tool is abnormal.

The inference calculation display unit 250 displays an evaluation value of the operation state of a machine tool calculated by the inference calculation unit 420 on the display 70 or the display 72 in association with a state amount or a context in a machining operation. The inference calculation display unit 250 may display an evaluation value of the operation state of a machine tool in association with time-series data of the state amount or a context in a machining operation, for example. Further, the inference calculation display unit 250 may display an evaluation value of the operation state of a machine tool in association with an instruction of a machining program that is one of the contexts in a machining operation, for example. With such display being performed, the operator is able to clearly recognize in which part the operation state of the machine tool is normal and in which part the operation state of the machine tool is abnormal.

The feature model generation unit 230 performs generation or update (machine learning) of a feature model stored in the feature model storage unit 350 based on a context in a machining operation input from the context acquisition unit 110 and on a feature amount indicating a feature of the operation state of a machine tool created by the feature amount creation unit 410. The feature model generation unit 230 selects a feature model targeted for generation or update based on a context in a machining operation input from the context acquisition unit 110 and performs, on the selected feature model, machine learning with a feature amount indicating a feature of the state of a machining operation created by the feature amount creation unit 410. When a feature model associated with (a combination of) contexts in a machining operation input from the context acquisition unit 110 is not stored in the feature model storage unit 350, the feature model generation unit 230 newly generates a feature model associated with (a combination of) contexts in the machining operation. When a feature model associated with (a combination of) contexts in a machining operation input from the context acquisition unit 110 is stored in the feature model storage unit 350, the feature model generation unit 230 updates the feature model by performing machine learning on the feature model. When a plurality of feature models associated with (a combination of) contexts in a machining operation input from the context acquisition unit 110 are stored in the feature model storage unit 350, the feature model generation unit 230 may perform machine learning on respective feature models or may perform machine learning on only some of the feature models based on the executable learning process or the machining capacity of the feature model generation unit 230.

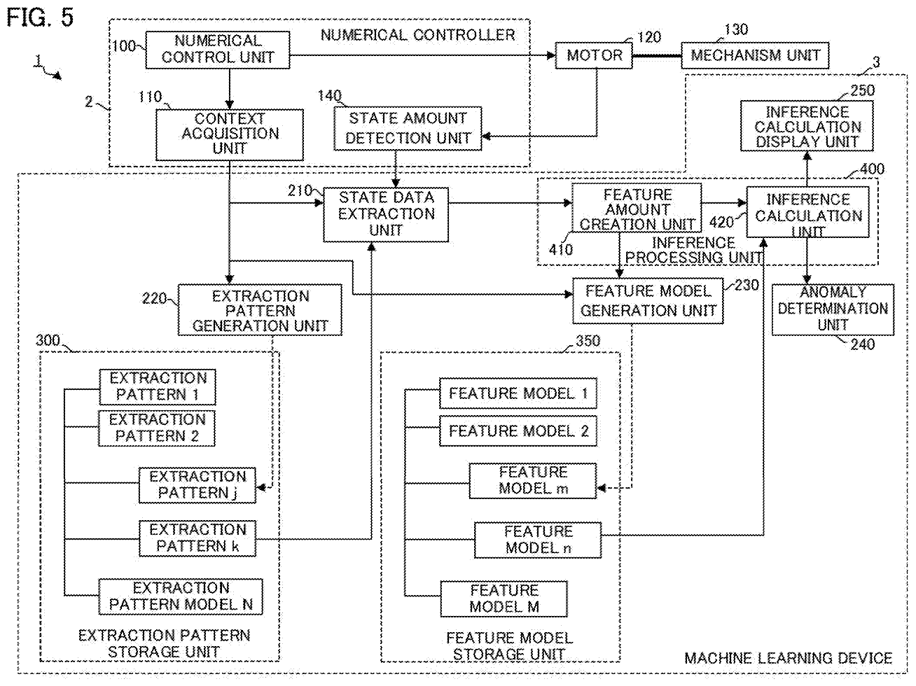

FIG. 5 is a schematic function block diagram of the numerical control system 1 according to a second embodiment. Each functional block illustrated in FIG. 5 is realized when the CPU 11 provided in the numerical controller 2 forming the numerical control system 1 illustrated in FIG. 1 or a processor 80 such as a GPU provided in the machine learning device 3 configured on a computer such as a fog computer, a cloud server, or the like controls the operation of respective components of the devices in accordance with respective system programs.

The numerical control system 1 of the present embodiment includes an extraction pattern storage unit 300 that stores and manages a plurality of extraction patterns and an extraction pattern generation unit 220 that creates and updates the extraction pattern stored in the extraction pattern storage unit 300 in addition to the configuration provided in the numerical control system of the first embodiment.

The extraction pattern storage unit 300 of the present embodiment can store a plurality of extraction patterns associated with a combination of contexts in a machining operation input from the context acquisition unit 110. The extraction pattern storage unit 300 can be implemented as a numerical controller, a cell computer, a fog computer, a cloud server, a database server, or the like, for example.

The extraction pattern storage unit 300 stores a plurality of extraction patterns 1, 2, . . . , N associated with a combination of contexts (machining status, operation status, environmental status, or the like) in a machining operation specified by the context acquisition unit 110. The combination of contexts (machining status, operation status, environmental status, or the like) in a machining operation as used herein means a combination related to values, a range of values, or a list of values that may be taken by respective contexts in machining operations. For example, when the combination of contexts is a combination of a spindle rotational rate, a feed rate, a cutting signal, a tool type, and work information, “spindle rotational rate: 500 to 1000 [min⁻¹], feed rate: 200 to 300 [mm/min], during cutting, drill tool, aluminum/steel” can be used as one of the combinations of contexts in the machining operation.

With respect to each of the extraction patterns stored in the extraction pattern storage unit 300, one extraction pattern used for extraction of state data in the state data extraction unit 210 is stored as configurable information. Each of the extraction patterns stored in the extraction pattern storage unit 300 corresponds to a predetermined data machining method in which the parameter is determined based on a context in a machining operation, which may be setting of an extraction section of time-series data derived based on a context in a machining operation, selection of data, edition of data such as a scale change of the state amount based on a context in a machining operation, or the like, for example. Respective extraction patterns stored in the extraction pattern storage unit 300 may be extraction patterns using the same algorithm or may be extraction patterns using different algorithms.

In response to externally receiving a read/write request of an extraction pattern including a combination of contexts in a machining operation, the extraction pattern storage unit 300 performs reading/writing on the extraction pattern stored in association with the combination of contexts in the machining operation. The extraction pattern storage unit 300 may have a function by which reading/writing is performed on an extraction pattern associated with (a combination of) contexts in the machining operation based on the contexts in the machining operation input from the context acquisition unit 110 in response to an external read/write request of an extraction pattern. With such a function being provided, it is no longer necessary to additionally provide a function of requesting an extraction pattern based on a context input from the context acquisition unit 110 to the state data extraction unit 210 or the extraction pattern generation unit 220.

Note that the extraction pattern storage unit 300 may encrypt and store an extraction pattern generated by the extraction pattern generation unit 220 and decrypt the encrypted extraction pattern when the extraction pattern is read by the state data extraction unit 210.

The extraction pattern generation unit 220 performs generation or update of an extraction pattern stored in the extraction pattern storage unit 300 based on a context in a machining operation input from the context acquisition unit 110 and on a state amount of the operation state of a machine tool detected by state amount detection unit 140. The extraction pattern generation unit 220 selects a feature model targeted for generation or update based on a context in a machining operation input from the context acquisition unit 110 and sets a data edition method for defining how to extract state data from the state amount determined by the state amount detection unit 140 based on a context in a machining operation for the selected extraction pattern. Typically, the extraction pattern generation unit 220 performs creation and update of an extraction pattern based on an operation of an input unit (not illustrated) performed by an operator or the like. When an extraction pattern associated with (a combination of) contexts in a machining operation input from the context acquisition unit 110 is not stored in the extraction pattern storage unit 300, the extraction pattern generation unit 220 newly generates an extraction pattern associated with (a combination of) contexts in the machining operation based on the operation performed by the operator or the like. When an extraction pattern associated with (a combination of) contexts in a machining operation input from the context acquisition unit 110 is stored in the extraction pattern storage unit 300, the extraction pattern generation unit 220 updates the extraction pattern by setting the extraction pattern or the like based on the operation performed by the operator or the like for the extraction pattern.

According to the numerical control system 1 of the present embodiment having the above configuration, based on which extraction pattern the state data extraction unit 210 extracts state data from a state amount determined by the state amount detection unit 140 can be determined based on a context in a machining operation input from the context acquisition unit 110. In determination on the operation state of a machine tool, one may intend to change the temporal timing or section of state data to be extracted or the type of the state amount used for the determination of the operation state of a machine tool in respective contexts of machining operations. For example, when one intends to determine the operation of a spindle in a situation of a test operation, since machining on a work or the like is not performed in particular, an extraction pattern to extract a state amount in a section where a predetermined requirement defined in advance (that the spindle rotates at around 4000 rpm) is satisfied can be used at random as state data. However, when one intends to perform the same determination while the machining is being performed on a work as illustrated as an example in FIG. 4, to extract the state amount in a section where a tool runs idle and performs no machining as state data, it is desirable to use an extraction pattern to limit a section from which a cutting signal that is a context in a machining operation is extracted as a parameter. Furthermore, when one intends to determine the operation state of a machine tool (the attachment state of a tool) after a tool is replaced, it is required to use an extraction pattern to extract state data of the section immediately after completion of the replacement of the tool from a state amount which is different in type from that in the determination on the operation of the spindle (a feature model used for inference performed by the inference calculation unit 420 at this time is accordingly switched to a feature model used for determining the attachment state of the tool). As discussed above, the state data extraction unit 210 switches the extraction pattern used for extracting state data from a state amount in accordance with a context in a machining operation input from the context acquisition unit 110, thereby it is possible to perform extraction of suitable state data in accordance with a situation, and it is possible to efficiently and more accurately perform a process related to machine learning performed by the feature model generation unit 230 based on the state data or an inference process performed by the inference calculation unit 420.

Note that an extraction pattern stored in the extraction pattern storage unit 300 according to the present embodiment may be configured as including a so-called learning model of machine learning in the same manner as a feature model. When an extraction pattern is configured as including a learning model, an extraction pattern may be configured as a single learning model in which a predetermined state amount and a context in a predetermined machining operation are the input and state data to be extracted is the output, or an extraction pattern may be configured by combining a rule used for selecting state data from a state amount and one or a plurality of learning models in which a selected state amount and a predetermined context are the input and state data to be extracted is the output, for example. When configured as a model using a learning algorithm of a multilayer neural network, for example, the extraction pattern stored in the extraction pattern storage unit 300 may be stored as the number of neurons (perceptrons) in each layer, a weight parameter between neurons (perceptrons) in each layer, or the like. Further, when configured as a model using a learning algorithm of a Bayesian network, the extraction pattern may be stored as a transition probability between nodes forming the Bayesian network or the like. When configured in such a way, respective extraction patterns stored in the extraction pattern storage unit 300 may be extraction pattern using the same learning algorithm or may be extraction pattern using different learning algorithms, which may be an extraction pattern using any learning algorithms as long as it can be utilized for the state data extraction process performed by the state data extraction unit 210.

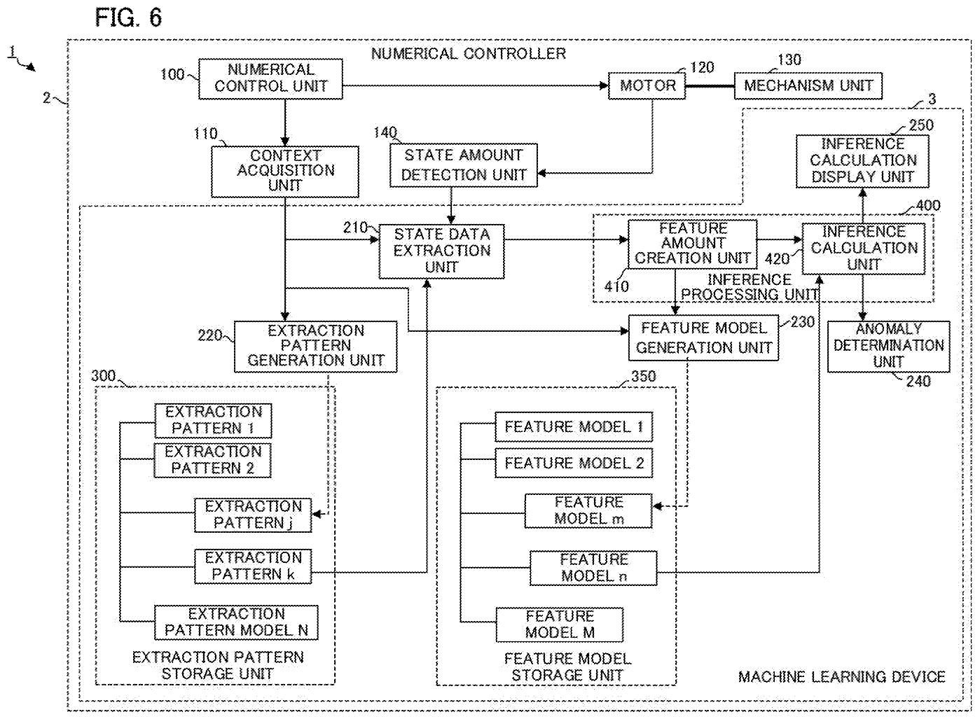

FIG. 6 is a schematic block diagram of the numerical control system 1 according to a third embodiment. In the numerical control system 1 of the present embodiment, all the function blocks are implemented in a single component of the numerical controller 2. With such a configuration, for example, the numerical control system 1 of the present embodiment can extract state data by using a suitable extraction pattern in accordance with a context in a machining operation such as an operation pattern of the motor 120 in a machining operation with a machine tool controlled by the numerical controller 2, a type of a tool used for machining, or a material of a work and determine the operation state of the machine tool using a suitable feature model. Further, respective extraction patterns or learning models can be generated/updated in accordance with a context in a machining operation by using a single numerical controller 2.

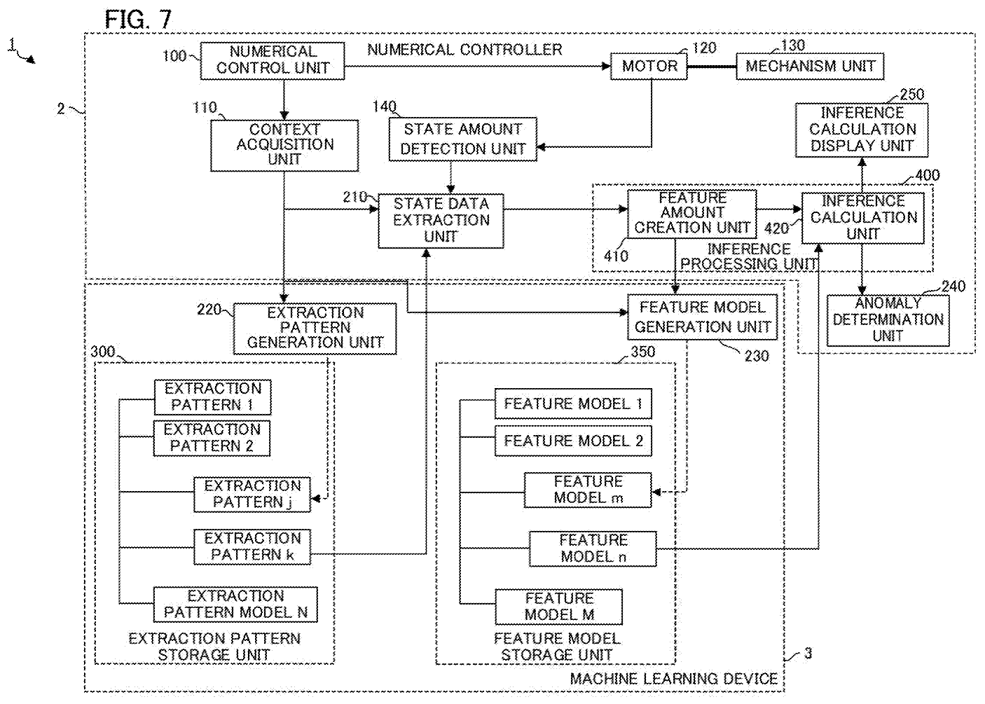

FIG. 7 is a schematic block diagram of the numerical control system 1 according to a fourth embodiment. In the numerical control system 1 of the present embodiment, the inference machining unit 200, the anomaly determination unit 240, and the inference calculation display unit 250 are implemented in the numerical controller 2, and the extraction pattern storage unit 300, the feature model storage unit 350, or the like are implemented in the machine learning device 3 connected to the numerical controller 2 via a typical interface or network. The machine learning device 3 may be implemented in a cell computer, a fog computer, a cloud server, or a database server. With such a configuration, since the inference process using a feature model that is a process of relatively light load can be performed in the numerical controller 2 and the process of generating/updating a model that is a process of relatively heavy load can be performed in the machine learning device 3, it is possible to operate the numerical control system 1 without interfering with a process of controlling a machine tool performed in the numerical controller 2.

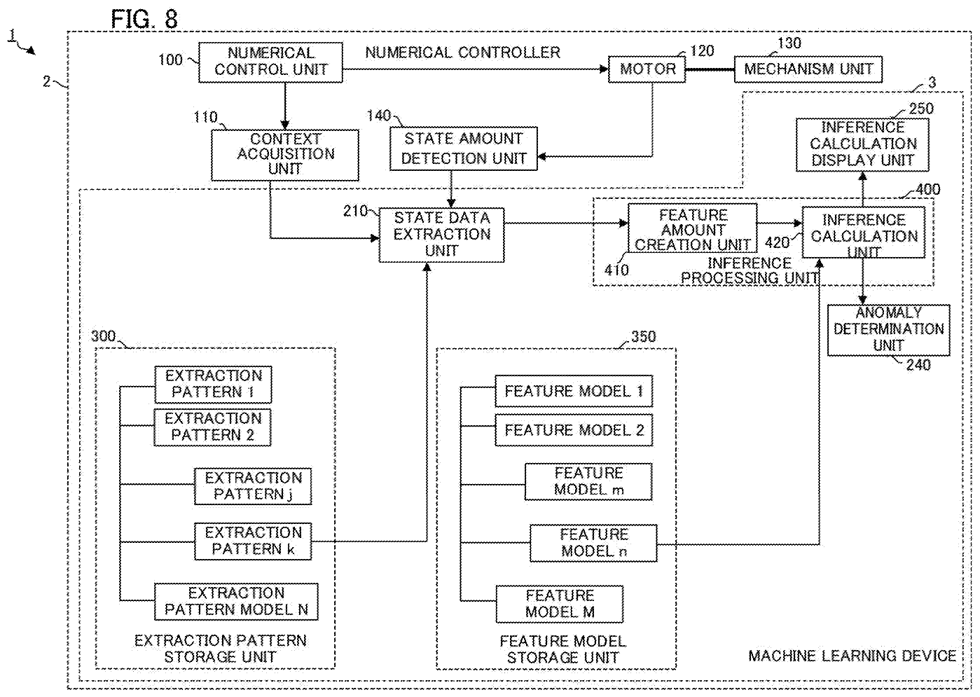

FIG. 8 is a schematic block diagram of the numerical control system 1 according to a fifth embodiment. In the numerical control system 1 of the present embodiment, all the function blocks are implemented in a single component of the numerical controller 2. Note that, in the numerical control system 1 of the present embodiment, it is assumed that a plurality of extraction patterns and a plurality of feature models associated with combinations of contexts in respective machining operations are already stored in the extraction pattern storage unit 300 and the feature model storage unit 350 and no generation/update is performed on the extraction pattern or the feature model, and accordingly the configuration of the extraction pattern generation unit 220 and the feature model generation unit 230 is omitted. Such a configuration enables the numerical control system 1 of the present embodiment to determine the operation state of a machine tool by using an extraction pattern or a feature model that may differ in accordance with the context such as the type of a tool attached to the machine tool controlled by the numerical controller 2, the material of a work, or the like, for example. Further, since unauthorized update of the extraction pattern or the feature model would not be performed, the above configuration can be employed for the configuration of the numerical controller 2 shipped to a customer, for example.

While the embodiments of the present invention have been described above, the present invention is not limited to only the examples in the embodiments described above and can be implemented in various forms by adding an appropriate change.

1. A numerical control system that determines an operation state of a machine tool, the numerical control system comprising:
a context acquisition unit that acquires a context in a machining operation of the machine tool;
a state amount detection unit that determines a state amount related to an operation state of the machine tool;
a state data extraction unit that extracts state data from the state amount by using an extraction pattern based on the context in the machining operation acquired by the context acquisition unit;
a feature amount creation unit that creates a feature amount featuring the operation state of the machine tool from the state data;
an inference calculation unit that calculates an evaluation value of the operation state of the machine tool based on the feature amount; and
an anomaly determination unit that determines the operation state of the machine tool based on a calculation result from the inference calculation unit.

2. The numerical control system according to claim 1, further comprising an extraction pattern storage unit that stores a plurality of extraction patterns associated with the context in the machining operation of the machine tool, respectively,
wherein the state data extraction unit extracts state data from the state amount by using an extraction pattern selected from the extraction pattern storage unit based on the context in the machining operation acquired by the context acquisition unit.
